(19) United States
(12) Patent Application Publication
(10) Pub. No.: US 2012/0233776 A1
(43) Pub. Date: Sep. 20, 2012

(54) BED SHEET SET WITH CONNECTING MECHANISM

(76) Inventor: Arun Agarwall, Dallas, TX (US)

(21) Appl. No.: 13/420,733

(22) Filed: Mar. 15, 2012

Related U.S. Application Data
(60) Provisional application No. 61/453,088, filed on Mar. 15, 2011.

(51) Int. Cl. A47G 9/04; B23P 11/00

(52) U.S. Cl. 5/496; 29/525.03

(57) ABSTRACT

An improved system for retaining a top bed sheet onto a bottom bed sheet is disclosed using a plurality of attachment mechanisms. In one exemplary approach a first attachment device is associated with the top sheet and a second attachment device is associated with a bottom sheet. The attachment devices are complementary in both operation and location such that the first attachment device selectively engages the second attachment mechanism to customize the desired positioning and retention of the top sheet with respect to the bottom sheet.

### CROSS-REFERENCE TO RELATED APPLICATION

This application claims the benefit of U.S. Provisional Application No. 61/453,088, filed Mar. 15, 2011, the disclosure of which is hereby incorporated by reference in its entirety.

### FIELD

The present disclosure relates generally to bed sheets and, more particularly, to bed sheets used to cover a mattress where a connecting mechanism is used to attach a top bed sheet to a bottom bed sheet to assure alignment of the top bed sheet relative to the bottom bed sheet.

### BACKGROUND

Conventional bottom bed sheets are well known, which are sized and fashioned to be tucked under a bed mattress. Alternatively, they can be fashioned as a fitted sheet to snuggly fit and be retained to a bed mattress using a plurality of corner pockets that engage corresponding corners on the mattress. In yet another approach, the bottom sheet can include elastic material at the corners, which are looped over the corners of the mattress to hold the bottom sheet in place on the mattress.

The top sheet is typically centered on the mattress over the bottom sheet and the overhanging edges are tucked under the mattress to hold it in place. Often, this approach is unsatisfactory because the top sheet can be pulled out from under the mattress by the user and the top sheet can then be moved relative to the bottom sheet and can, in fact, end up off the bed mattress entirely. It would be desirable to employ a top sheet retention system that would hold the top sheet relative to the bottom sheet that would be easy to use and would be comfortable to the user.

### SUMMARY

The exemplary bed sheet set provides an effective structure for positioning a top sheet relative to a bottom sheet where the bottom sheet is securely positioned on a mattress by tucking the corners of the bottom sheet under the mattress or by forming corner pockets in the bottom sheet and pulling these corner pockets over respective corners of the mattress. The disclosed exemplary connecting mechanism is used to attach a top sheet to a bottom sheet at the foot of the bed. The connecting mechanism secures the top sheet in position while providing comfort to the user. Various attachment devices may be used in combination with the connecting mechanism including, but not limited to, buttons and buttonholes, hooks and loops, and snaps. The connecting mechanism is positioned on both the bottom and top sheets to be located on both sides of two adjacent corners of the foot of the mattress. Thus, a first attachment device of the connecting mechanism is secured to the bottom sheet at either side of the corner pocket and a second attachment device of the connecting mechanism is secured or formed in the top sheet at positions that will result in the top sheet being properly positioned relative to the bottom sheet when the corresponding first and second parts of the connecting mechanism are joined. Thus, according to the present disclosure, the exemplary bed sheet set uses a connecting mechanism between the top and bottom sheet to hold the top sheet in place where the connecting mechanism is made up of a first attachment device that engages a second attachment device.

### BRIEF DESCRIPTION OF THE DRAWINGS

FIG. 1 is a schematic perspective view of a bottom fitted sheet showing a first attachment device of the exemplary connecting mechanism for attaching a top sheet to the bottom fitted sheet;

FIG. 2 is a schematic perspective view of the top sheet showing a second attachment device of the exemplary connecting mechanism;

FIG. 3 is a schematic perspective view of the top sheet positioned over the bottom fitted sheet, prior to connecting the first attachment device to the second attachment device; and

FIG. 4 is a schematic perspective view of a bed sheet set, including a bottom fitted sheet and a top sheet, employing an alternative connecting mechanism.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

In this disclosure, certain terminology will be used in the following description for convenience in reference only and will not be limiting. The terms “rightward” and “leftward” will refer to directions in the drawings in connection with which the terminology is used. The terms “inwardly” and “outwardly” will refer to directions toward and away from, respectively, the geometric center of the referenced structure. The terms “upward” and “downward” will refer to directions as taken in the drawings in connection with which the terminology is used. All foregoing terms mentioned above include the normal derivatives and equivalents thereof

Moreover, a number of constants may be introduced in the discussion that follows. In some cases illustrative values of the constants are provided. In other cases, no specific values are given. The values of the constants will depend on characteristics of the associated hardware and the interrelationship of such characteristics with one another as well as environmental conditions and the operational conditions associated with the disclosed system.

While the invention will be described in connection with certain exemplary approaches, it will be understood that there is no intention to limit the invention to the construction shown. On the contrary, it is intended to cover the various alternative and equivalent constructions included within the spirit and scope of the appended claims.

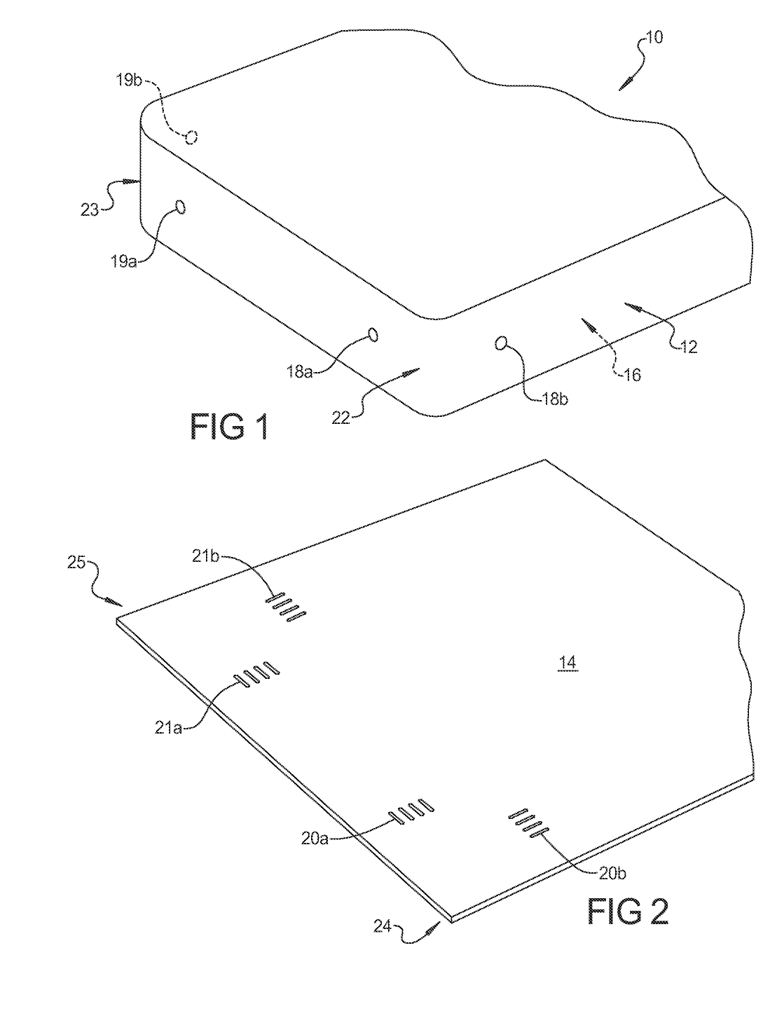

Referring to FIGS. 1 and 2, an exemplary bed sheet set 10 mounted to a bed mattress is shown and includes a bottom sheet 12, which is shown as a fitted bottom sheet, but can be an unfitted type of bottom sheet and a top sheet 14 fashioned to cover a four corner mattress 16. The bottom sheet 12 has first attachment devices 18a, 18b, which are shown in FIGS. 1&3 as buttons and the top sheet 14 has corresponding second attachment devices 20a, 20b, which are shown in FIGS. 2&3 as buttonholes. The first attachment devices (buttons) 18a and 18b engage corresponding second attachment devices (buttonholes) 20a and 20b and the first attachment devices (buttons) 19a and 19b engage corresponding second attachment devices (buttonholes) 21a and 21b for allowing the tension on the top sheet 14 to be adjusted by selection of an appropriate buttonhole. A plurality of buttonholes is shown as the second attachment devices 20a, 20b, 21a, 21b. The first attachment devices 18a, 18b and 19a, 19b are shown in FIGS. 1&3 as buttons secured to the bottom sheet 12 and the second attachment devices 20a, 20b and 21a, 21b are shown in FIGS. 2&3 as corresponding buttonholes formed in the top sheet 14. Attachment devices 18a and 18b are secured on both sides of a first corner pocket 22 of the fitted bottom bed sheet 12 and attachment devices 19a and 19b secured to both sides of the second corner pocket 23 of the fitted bottom bed sheet 12. The placement of the first attachment devices 18a, 18b and 19a, 19b depend on the placement of the corresponding second attachment devices 20a, 20b and 21a, 21b formed in the top sheet 14. The placements of these attachment devices are selected to produce the desired orientation between the top sheet 14 and the bottom sheet 12 and one of the first attachment devices engage an appropriate respective one of the second attachment devices to form a connecting mechanism as shown in FIGS. 1-3 where this connecting mechanism is a button and buttonhole combination.

FIG. 1 shows a perspective view of a fitted bottom sheet 12 although a plain flat sheet can be used. First and second corner pockets 22, 23 are formed at two of the four corners of the bottom sheet 12. These corner pockets 22, 23 are pulled down over the corresponding four corners of the mattress 16 to secure the bottom sheet 12 in place, at least generally centered on the mattress 16. Two or more first attachment devices 18a, 18b, are shown as buttons and are attached to the bottom sheet 12 at both sides of the corner pocket 22. Two or more first attachment devices 19a, 19b are shown as buttons and are attached to the bottom sheet 12 at both sides of the corner pocket 23. Corner pockets 22 and 23 are at the foot of the bed mattress 16.

FIG. 2 shows a perspective view of the top sheet 14 lying flat prior to placement on the bottom sheet 12 on the mattress 16. Second attachment devices 20a, 20b, 21a, 21b are shown as buttonholes formed in the top sheet 14. The second attachment devices 20a and 20b are shown as a plurality of slots formed at approximately a right angle one to the other at the first corner 24 of the top sheet 14. The second attachment devices 21a and 21b are shown as a plurality of slots formed at approximately a right angle one to the other at the second corner 25 of the top sheet 14.

The corners 24 and 25 are drawn over the pocket corners 22 and 23 respectively of the bottom sheet 12 and the first attachment devices (buttons) 18a and 18b are inserted into corresponding selected second attachment devices 20a and 20b (buttonholes) while the first attachment devices (buttons) 19a and 19b are inserted into corresponding selected second attachment devices 21a and 21b (buttonholes). Depending on which buttonholes are used will determine the applied tension on the top sheet 14. These mating attachment devices 18a, 18b, 19a, 19b, 20a, 20b, 21a, 21b comprise the connecting mechanism that secure the top sheet 14 in position relative to the bottom sheet 12. The two corner pockets 22 and 23 and the corners 24 and 25 of the top sheet 14 are positioned on the mattress 16 at the end where the user's feet would be located.

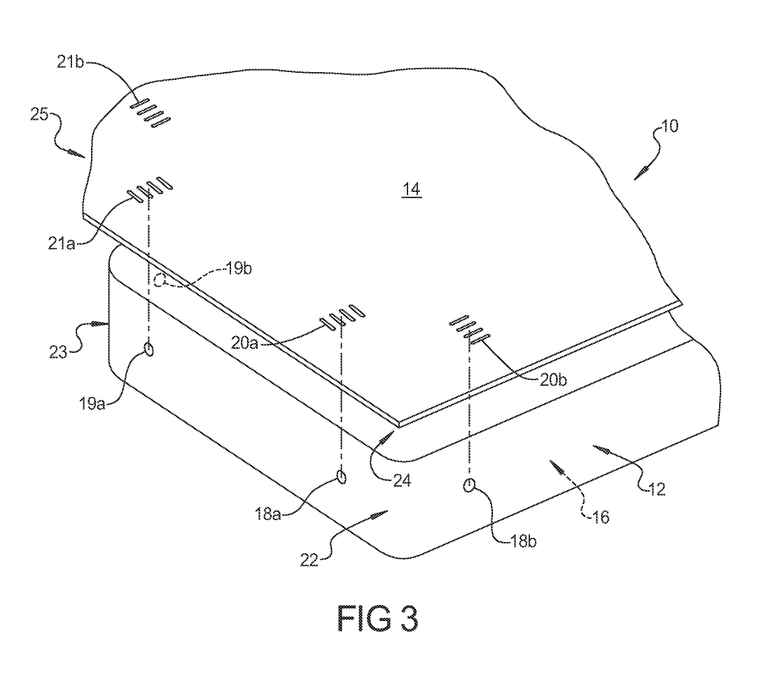

FIG. 3 is a partial perspective view of a mattress 16 with the top sheet 14 placed over the bottom sheet 12, but the attachment devices 18, 19 have not been engaged. The bottom sheet 12 is shown as a fitted sheet, but a flat sheet could be used as well. The bottom sheet 12 has the corner pockets 22 and 23 pulled down over the corners of the mattress 16 and is fully installed thereon. The top sheet 14 is shown in a partially installed position with the second attachment devices (buttonholes) 20a, 20b, and 21a, 21b positioned above the first attachment devices (buttons) 18a, 18b and 19a, 19b respectively but not yet engaged one to the other to secure the top sheet 14 to the bottom sheet 12. At this stage, the next installation step would be for the top sheet 14 to be pulled over the bottom sheet 12 at the corner pockets 22 and 23 so that the first attachment devices 18a, 18b and 19a, 19b could be inserted into their respective second attachment devices 20a, 20b and 21a, 21b to hold the top sheet 14 in position relative to the bottom sheet 12. Multiple buttonholes are shown formed in the top sheet 14. Any one of these may be selected for the insertion of a corresponding button so as to give the desired tension on the top sheet 14. A looser tension might be more comfortable, for example, for the positioning of the user's feet.

The positions of the buttons and the buttonholes could be reversed with the first attachment devices 18a, 18b, 19a, and 19b secured to the top sheet 14 and the second attachment devices 20a, 20b, 21a and 21b formed in the bottom sheet 12 or some combination thereof. In some illustrative approaches, for example, attachment devices 181 19 and 20,21 may be staggered in some fashion between sheets 12 and 14 such that devices 18,19 (e.g., buttons) and 20,21 (e.g., buttonholes) are present on both sheets, but arranged such that an attachment device of one type (e.g., a button) on one sheet selectively engages a corresponding attachment device of a mating type (e.g., a button hole) on the corresponding sheet.

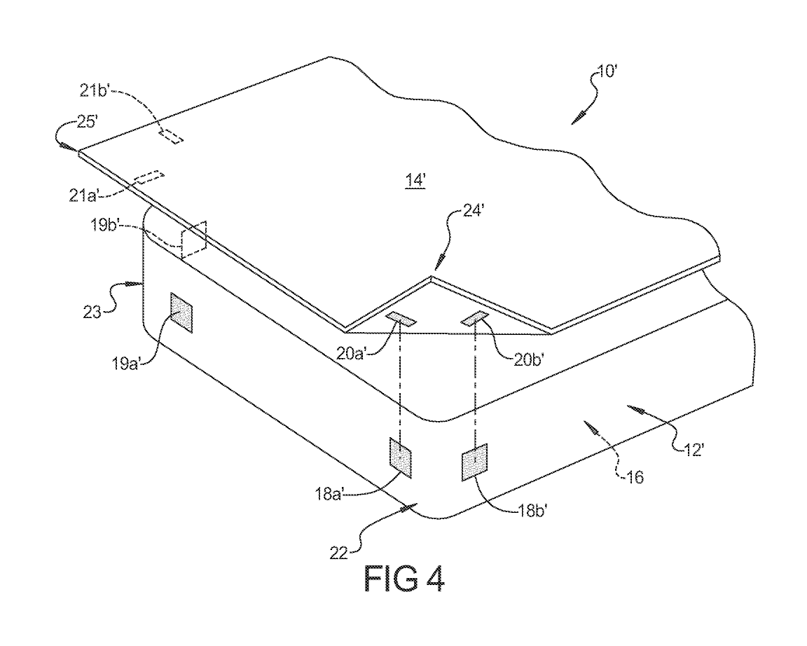

Now referring to FIG. 4 of the drawings, a partial perspective view of an alternate bed sheet set 10′ is shown. First and second attachment devices 18a′, 18b′, 19a′ 19b′, 20a′, 20b′, 21a′, 21b′ are shown in the form of hook and loop patches, each having a multiplicity of either hooks or loops that are attached to selected locations on the bottom sheet 12′ and the top sheet 14′ and comprise the connecting mechanisms used to secure the top sheet 14′ in position relative to the bottom sheet 12′. The bottom sheet 12′ is shown fully installed on a mattress 16 where the bottom sheet 12′ is a fitted type of bed sheet that has corner pockets 22 and 23 which have been pulled over and down to engage the two corners of the mattress 16 thereby securing the bottom sheet 12′ to the mattress 16. One commercial type of hook and loop connecting mechanism is known as “Velcro,” which can be used to effectively connect one object to another, but can be removed if the Velcro is peeled apart.

The bottom sheet 12′ has first attachment devices (hooks or loops) 18a′, 18b′ and 19a′, 19b′ attached to both sides of the corner pockets 22 and 23 respectively. The top sheet 14′ is shown only partially installed over the bottom sheet 12′. The top sheet 14′ has mating second attachment devices (loops or hooks) 20a′, 20b′ and 21a′, 21b′ secured in position on the top sheet 14′ to properly engage the first attachment devices 18a′, 18b′ and 19a′, 19b′ respectively when the top sheet 14′ is pulled down over the bottom sheet 14′ at corners 24′ and 25′. Thus, when the top sheet 14′ is pulled down over the corner pockets 22′ and 24′, the first attachment device 18a′ engages second attachment device 20a′, first attachment device 18b′ engages second attachment device 20b′ to comprise one connecting mechanism, and first attachment device 19a′ engages second attachment device 21a′, first attachment device 19b′ engages second attachment device 21b′ to comprise a second connecting mechanism. Depending on how far down the top sheet 14′ is pulled over the bottom sheet 12′ before the first and second attachment devices are engaged will determine the tension on the top sheet 14′. Thus, the first and second attachment devices 18a′, 18b′, 19a′, 19b′ and 20a′, 20b′ and 21a′, 21b′ must be secured to the bottom and top sheets 12′, 14′ respectively in a location that permits the tension of the top sheet 14′ to be selected before engaging the first and second attachment devices 18a′, 18b′, 19a′, 19b′, 20a′, 20b′, 21a′, 21b′ to form the connecting mechanisms that connect the top sheet 14′ in position on the bottom sheet 12′. Again, the exemplary attachment devices could be interchanged or staggered.

Other forms of attachment devices could be used to comprise the connecting mechanism between the bottom sheet and the top sheet without departing from the spirit of the exemplary bed sheet set. Snaps, clips, staples and hooks are examples of known attachment devices that could be used in the place of buttons and buttonholes or hooks and loops to implement this exemplary bed sheet system. For example, when employing a snap type connector a male portion of the connector may be substituted for the button on the bottom fitted sheet and multiple female portions of the connector may be substituted for each of the buttonholes in the top sheet.

Referring once again to FIG. 4, a hook and loop type connecting mechanism, for example Velcro, may be substituted for each set of button and buttonhole connecting mechanism, such as illustrated in FIGS. 1-3. A corner 24 of the top sheet 14′ is shown raised up in FIG. 4 to reveal a member of the hook and loop connector attached to an underside surface of the top sheet 14′ (i.e. the side of the top sheet facing the mattress and labeled as second attachment device 20a′). One member of the hook and loop type connecting mechanism, such as the first attachment device 18a′, may be attached to the bottom fitted sheet 12′ and the remaining member, such as second attachment device 20a′, may be attached to the underside of the top sheet 14′. In a like manner the first attachment devices 18a′, 18b′, 19a′, 19b′ are secured to the bottom sheet 12′ and the second attachment device 20a′, 20b′, 21a′, 21b′ are secured to the top sheet 14′. The attachment devices 18a′, 18b′, 19a′, 19b′, 20a′, 20b′, 21a′, 21b′ are positioned to yield the desired tension on the top sheet 14′ when the various attachment devices are joined to form the connecting mechanisms.

The first attachment devices 18a′, 18b′, 19a′, 19b′ can be hooks and/or loops and the corresponding second attachment devices 20a′, 20b′, 21a′, 21b′ must be the opposite of the hooks and/or loops of the first attachment devices so that they engage one another to hold the top sheet 14′ to the bottom sheet 12′. The first attachment devices 18a′, 18b′, 19a′, 19b′ and the second attachment devices 20a′, 20b′, 21a′, 21b′ are of a different size to allow for adjustment of the tension of the top sheet 14′. In FIG. 4, the first attachment devices 18a′, 18b′, 19a′, 19b′ are shown as being larger than the second attachment devices 20a′, 20b′, 21a′, 21b′ but that size differential could be switched without affecting the functionality of the bed sheet set 10′.

Referring to the bed sheet sets 10 and 10′ of FIGS. 1-4, by providing attachment devices that are generally equally spaced from the centerline of the corners 22, 23 of the bottom sheet 12, 12′ helps to more evenly distribute the forces in the bottom sheet 12, 12′ and in the top sheet 14, 14′ and thereby avoid damage to one or more of the attachment devices such as 18a and 20a. Also, the retention of the top sheet 14, 14′ is improved by attaching the top sheet 14, 14′ on both the bottom of the top sheet 14, 14′ and on the side of the bottom sheet 12, 12′. This arrangement places the attachment devices in shear, which improves the retention force.

To further improve retention, two or more buttons could be secured to the bottom sheet 12 at the same side of the same corner and these buttons would engage corresponding buttonholes found in the top sheet 14. It would also be possible to use a plurality of connecting mechanisms along the foot of the bottom sheet 12, 12′ in addition to one or more at the side of each corner of the bottom sheet 12, 12′ to better retain the top sheet 14, 14′ relative to the bottom sheet 12, 12′ but that would increase the cost and potentially compromise the comfort of the user.

It will be appreciated that the exemplary bed sheet connecting mechanism described herein has broad applications. The foregoing configurations were chosen and described in order to illustrate principles of the methods and apparatuses as well as some practical applications. The preceding description enables others skilled in the art to utilize methods and apparatuses in various configurations and with various modifications as are suited to the particular use contemplated. In accordance with the provisions of the patent statutes, the principles and modes of operation of the disclosed bed sheet connecting mechanisms have been explained and illustrated in exemplary configurations.

The present disclosure has been particularly shown and described with reference to the foregoing illustrations, which are merely illustrative of the best modes for carrying out the disclosure. It should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure and that the method and apparatus within the scope of these claims and their equivalents be covered thereby. This description of the disclosure should be understood to include all novel and non-obvious combinations of elements described herein, and claims may be presented in this or a later application to any novel and non-obvious combination of these elements. Moreover, the foregoing illustrations are illustrative, and no single feature or element is essential to all possible combinations that may be claimed in this or a later application.

1. A bed sheet set comprising:
a bottom sheet configured to drape over an underlying mattress;
a top sheet configured to drape over the bottom sheet and underlying mattress; and
at least one connecting mechanism for selectively attaching the top sheet to the bottom sheet, said connecting mechanism including a first attachment device attached to said bottom sheet and a second attachment device attached to said top sheet, said first attachment device selectively engaging said second attachment device.

2. The bed sheet set of claim 1, wherein said connecting mechanism is a button, which engages a buttonhole.

3. The bed sheet set of claim 2, wherein said buttons or buttonholes are positioned on both sides of two adjacent corner pockets formed in said bottom sheet.

4. The bed sheet set of claim 2, wherein said buttons or buttonholes are positioned equidistant one from the other on both sides of two adjacent corners of said top sheet such that when said buttons engage corresponding buttonholes said top sheet is held onto said bottom sheet in a desired position.

5. The bed sheet set of claim 2, wherein said buttons or buttonholes are positioned equidistant one from the other on both sides of two adjacent corner pockets formed in said bottom sheet.

6. The bed sheet set of claim 1, wherein said connecting mechanism is comprised of a plurality of buttons and corresponding buttonholes.

7. The bed sheet set of claim 1, wherein said connecting mechanism is comprised of one button, which engages one of a plurality of buttonholes.

8. The bed sheet set of claim 1, wherein said first attachment device is a button and said second attachment device is a buttonhole.

9. The bed sheet set of claim 1, wherein said connector mechanism is comprised of a plurality of hook and loop attachment devices, with a first attachment device secured to said bottom sheet and a second attachment device secured to said top sheet.

10. The bed sheet set of claim 9, wherein said hooks or said loops are positioned equidistant one form the other on both sides of two adjacent corner pockets formed in said bottom sheet.

11. The bed sheet set of claim 9, wherein said hooks or said loops are positioned at least generally equidistant one form the other on both sides of two adjacent corners of said top sheet.

12. The bed sheet set of claim 9, wherein said hooks or said loops are positioned on both sides of two adjacent corners of said top sheet such that when said hooks engage said loops said top sheet is held onto said bottom sheet in a desired position.

13. The bed sheet of claim 8, wherein said first attachment device is a multiplicity of hooks or loops and said second attachment device is a multiplicity of hooks or loops.

14. A bed sheet set for installation on a mattress comprising:
a bottom sheet, said bottom sheet having a plurality of first attachment devices secured to said bottom sheet and positioned to be at both sides of a corner of said mattress when said bottom sheet is installed on said mattress; and
a top sheet, said top sheet having a plurality of second attachment devices secured to said top sheet and positioned to engage said first attachment devices on said bottom sheet when said top sheet is installed onto said bottom sheet.

15. The bed sheet of claim 14, wherein said first and second attachment devices are buttons or buttonholes

16. The bed sheet of claim 14, wherein said first attachment device is a button, which engages one of a plurality of buttonholes.

17. The bed sheet of claim 14, wherein said first or second attachment devices are hooks or loops.

18. A method of making a bed sheet set comprising:
providing a bottom sheet for covering a mattress;
providing a top sheet to cover said bottom sheet and substantially all of said mattress; and
securing a plurality of connecting mechanism between said top sheet and said bottom sheet at a foot of said mattress to secure said top sheet to said bottom sheet.

19. The method of making a bed sheet of claim 20, wherein said connecting mechanism is a button, which engages a buttonhole.

20. The method of making a bed sheet of claim 20, wherein said connecting mechanism is a hook, which engages a loop.
